(19) United States
(12) Patent Application Publication
(10) Pub. No.: US 2012/0033741 A1
(43) Pub. Date: Feb. 9, 2012

(54) DECODING OF A DIGITAL SIGNAL COMPRISING AT LEAST ONE SAMPLE

(75) Inventors: Eric Nassor, Thorigne Fouillard (FR); Hervé Le Floch, Rennes (FR); Naël Ouedraogo, Maure de Bretagne (FR)

(73) Assignee: CANON KABUSHIKI KAISHA, Tokyo (JP)

(21) Appl. No.: 12/849,539

(22) Filed: Aug. 3, 2010

(51) Int. Cl. H04N 11/02

(52) U.S. Cl. 375/240.25; 375/E07.026

(57) ABSTRACT

The invention concerns the decoding of a digital signal comprising at least one encoded digital image, a digital image being represented by a plurality of samples. The decoding method comprises, when a part of one said encoded digital image to be decoded is missing, applying a first decoding to the encoded digital image having the missing part so as to obtain a first decoded image, the first decoding involving setting a missing sample, being one of said samples in said missing part, to a first value. A second decoding is applied to said first decoded image using additional data, derived by the encoder from at least part of the encoded digital image and usable during decoding to correct the encoded digital image, to obtain a partially corrected symbol representative of said sample, said partially corrected symbol comprising at least one unknown bit. Finally, a second value for said missing sample is obtained based upon said first value and said partially corrected symbol. Thanks to this method, even a partial correction using additional data can be used to improve the values of missing samples of a digital image at the decoder side. As a result, the quality of reconstruction of missing parts of an image can be improved.

### FIELD OF THE INVENTION

The invention concerns a method and device for decoding a sequence of digital images containing at least one missing area.

The invention belongs to the domain of video processing in general and more particularly to the domain of decoding with reconstruction for missing parts, in particular using error concealment after the loss or corruption of part of the video data, for example by transmission through an unreliable channel.

### DESCRIPTION OF THE PRIOR-ART

Compressed video sequences are very sensitive to channel disturbances when they are transmitted through an unreliable environment such as a wireless channel. For example, in an IP/Ethernet network using the UDP (User Datagram Protocol) transport protocol, there is no guarantee that the totality of data packets sent by a server is received by a client. Packet loss can occur at any position in a bitstream received by a client, even if mechanisms such as retransmission of some packets or redundant data (such as error correcting codes) are applied.

In case of unrecoverable error, it is known, in video processing, to apply error concealment methods, in order to partially recover the lost or corrupted data, referred to as the missing area, from the compressed data available at the decoder.

Most video compression formats, for example H.263, H.264, MPEG1, MPEG2, MPEG4, SVC, called hereafter MPEG type formats, use block-based discrete cosine transform (DCT) and motion compensation to remove spatial and temporal redundancies. They can be referred to as predictive video formats. Each frame or image of the video sequence is divided into slices which are encoded and can be decoded independently. A slice is typically a rectangular portion of the image, or more generally, a portion of an image. Further, each slice is divided into macroblocks (MBs), and each macroblock is further divided into blocks, for example blocks of 8×8 pixels. The encoded frames are of two types: predicted frames (either predicted from one reference frame called P-frames or predicted from two reference frames called B-frames) and non predicted frames (called Intra frames or I-frames).

For a predicted P-frame, the following steps are applied at the encoder:

motion estimation applied to each block of the considered predicted frame with respect to a reference frame, resulting in a motion vector per block pointing to a reference block of the reference frame. The set of motion vectors obtained by motion estimation form a so-called motion field;

prediction of the considered frame from the reference frame, where for each block, the difference signal between the block and its reference block pointed to by the motion vector is calculated. The difference signal is called residual signal or residual data. A DCT is then applied to each block of residual data, and then, quantization is applied to the transformed residual data, and

entropic encoding of the motion vectors and of the quantized transformed residual data.

In the case of B-frames, two reference frames and two motion vectors are similarly used for prediction.

For an Intra encoded frame, the image is divided into blocks of pixels, a DCT is applied on each block, followed by quantization and the quantized DCT coefficients are encoded using an entropic encoder.

In practical applications, the encoded bitstream is either stored or transmitted through a communication channel.

At the decoder side, for the classical MPEG-type formats, the decoding achieves image reconstruction by applying the inverse operations with respect to the encoding side. For all frames, entropic decoding and inverse quantization are applied.

For Intra frames, the inverse quantization is followed by inverse block DCT, and the result is the reconstructed image signal.

For predicted frames, both the residual data and the motion vectors need to be decoded first. The residual data and the motion vectors may be encoded in separate packets in the case of data partitioning. For the residual data, after inverse quantization, an inverse DCT is applied. Finally, for each predicted block in the P-frame, the signal resulting from the inverse DCT is added to the reconstructed signal of the block of the reference frame pointed out by the corresponding motion vector to obtain the final reconstructed image block.

A video bitstream encoded with such a predictive format is highly sensitive to transmission errors, since an error will not only result in an incorrectly decoded image but will also propagate to the following images if the affected image is used as a reference image.

It is also known in the prior art to use a so-called Wyner-Ziv scheme to reconstruct missing parts of a video encoded according to a predictive format. A Wyner-Ziv scheme can be applied in various video processing scenarios, such as distributed coding or error resilience.

In a general view, the principle of a Wyner-Ziv scheme is to send from the encoder to the decoder a small amount of data, known as Wyner-Ziv additional data or encoded auxiliary data, which can be used at the decoder to improve a part of the video sequence that can be reconstructed or predicted from received video data.

One application of such a Wyner-Ziv scheme is error resilience, in case of transmission errors.

In the article “Rate allocation for robust streaming based on distributed video coding”, by R. Bernardini, M. Naccari, R. Rinaldo, M. Tagliasacchi, S. Tubaro and P. Zontine, published in Signal Processing: Image Communication in 2008, pages 391-403, the authors propose an error resolution method based on a Wyner-Ziv scheme, using Wyner-Ziv data to improve error concealment reconstruction at the decoder.

Auxiliary data is extracted from the original video data by applying block-based DCT transform, followed by the selection of some coefficients and a quantization of the selected coefficients. For each selected coefficient, a corresponding quantization interval value is encoded using a conventional binary encoding, and an error correction code is applied. The resulting error correction data is transmitted to the client as Wyner-Ziv encoded auxiliary data, in addition to the encoded video data.

The client receives both the video bitstream data and the encoded auxiliary data. Decoding and error concealment are applied on the received bitstream. Then, an approximate version of the auxiliary data is extracted from the result of the error concealment decoding and the received encoded auxiliary data, which is an error correction data of the auxiliary data, is used to correct the approximated version of the auxiliary data. The corrected auxiliary data is then used to improve the decoded image quality. In this article, the corrected auxiliary data is composed of quantization intervals, each corresponding to a DCT coefficient value predicted by error concealment and then corrected by the error correction decoding. An improved DCT coefficient value is selected inside the quantization interval provided by the error correction.

This prior art does not support partial error correction at the client side. Consequently, the article describes a very complex rate control algorithm at the server side, to determine a suitable size for the Wyner-Ziv data, so as to improve the amount of correction.

Therefore, there is a need to be able to improve the reconstruction of missing parts while keeping additional Wyner-Ziv of fixed size without implementing a complex rate distortion mechanism at the sender side.

### SUMMARY OF THE INVENTION

It is desirable to improve the quality of reconstruction of images of the video sequence even in case where some errors cannot be fully corrected using additional data.

To that end, one aspect of the invention relates to a method for decoding a digital signal comprising at least one encoded digital image, a digital image being represented by a plurality of samples. The method for decoding a digital signal comprises, when a part of one said encoded digital image to be decoded is missing:

applying a first decoding to said encoded digital image having the missing part so as to obtain a first decoded image, the first decoding involving setting a missing sample, being one of said samples in said missing part, to a first value,

applying a second decoding to said first decoded image using additional data, derived by the encoder from at least part of the encoded digital image and usable during decoding to correct the encoded digital image, to obtain a partially corrected symbol representative of said sample, said partially corrected symbol comprising at least one unknown bit, and

obtaining a second value for said missing sample based upon said first value and said partially corrected symbol.

The method as described above advantageously applies for the decoding of a video sequence, but can also be applied for the decoding of a still digital image. Thanks to this method, even a partial correction using additional data can be used to improve the values of missing samples of a digital image at the decoder side. As a result, the quality of reconstruction of missing parts of an image can be improved. Consequently, a better quality can be obtained, even when sending a quantity of additional data which is fixed arbitrarily. Any Wyner-Ziv decoding scheme can be improved using the method of the invention.

The invention also concerns a device for decoding a digital signal comprising at least one digital image encoded by an encoder, said digital image being represented by a plurality of samples. The device comprises:

a first decoding unit which, when a part of one said encoded digital image to be decoded is missing, applies a first decoding to said encoded digital image having the missing part so as to obtain a first decoded image, the first decoding unit involving setting a missing sample, being one of said samples in said missing part, to a first value,

a second decoding unit which applies a second decoding to said first decoded image using additional data, derived by the encoder from at least part of the encoded digital image and usable during decoding to correct the encoded digital image, to obtain a partially corrected symbol representative of said sample, said partially corrected symbol comprising at least one unknown bit, and

an obtaining unit which obtains a second value for said missing sample based upon said first value and said partially corrected symbol.

The device according to the invention comprises means for implementing all the steps of the method for decoding a digital signal according to the invention as briefly described above.

The invention also relates to a carrier medium, such as an information storage means, that can be read by a computer or a microprocessor, storing instructions of a computer program for the implementation of the method for decoding a digital signal as briefly described above.

The invention also relates to a computer program which, when executed by a computer or a processor in a device for decoding a digital signal, causes the device to carry out a method as briefly described above.

The particular characteristics and advantages of the decoding device, of the storage means and of the computer program being similar to those of the method of decoding a digital signal, they are not repeated here.

### BRIEF DESCRIPTION OF THE DRAWINGS

Other features and advantages will appear in the following description, which is given solely by way of non-limiting example and made with reference to the accompanying drawings, in which:

FIG. 1 is a schematic example of a communication system in which the invention can be implemented;

FIG. 2 illustrates a block diagram of a client device adapted to incorporate the invention;

FIG. 3 illustrates a block diagram of a server and a client in a first embodiment of the invention;

FIG. 4 illustrates an embodiment of auxiliary data extraction and generation;

FIG. 5 illustrates a typical distribution of the values of a given DCT coefficient in a current image;

FIG. 6 represents graphically a parity check matrix H of a very simple linear code of size (7,4);

FIG. 7 is a flowchart of an embodiment of an error correction decoding according to an embodiment of the invention;

FIG. 8 illustrates examples of first and second values according to an embodiment of the invention;

FIG. 9 is a flowchart illustrating an embodiment of the improving of transform coefficients according to an embodiment of the invention, and

FIG. 10 represents describes a distributed video coding system in which a second embodiment of the invention can be applied.

### DETAILED DESCRIPTION OF THE EMBODIMENTS

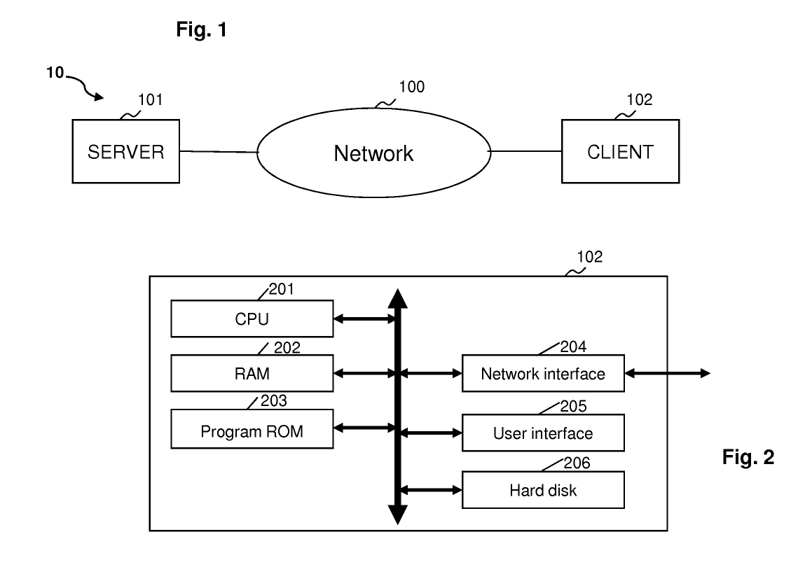

FIG. 1 represents a schematic example of a communication system 10 in which the invention can be implemented. The communication system 10 comprises a server device 101 which is adapted to transmit data packets of a data stream to a receiving device or client device 102, via a communication network 100.

The communication network 100 may for example be a wireless network (Wifi/802.11a or b or g), an Ethernet network, or the Internet network or a mixed network composed of several different networks.

As the transmission over the communication network 100 is not reliable, some errors can occur during the transmission. In particular, data packets may be lost, in case of congestion or interferences.

The system 10 may be a broadcast system, in which server 101 sends data streams to a plurality of client devices 102 at the same time.

In an application scenario of the invention, the data stream sent between the server 101 and the client 102 is a video sequence, encoded according to a predictive encoding format using motion compensation such as H264 or MPEG2. These formats provide compressed video data according to distortion-rate criteria, so as to provide videos at bitrates compatible with the bandwidth actually available on the network 100.

The encoded data are divided and encapsulated into transmission packets which are transmitted to the client 102 by the network 100 using a communication protocol, for example RTP (Real-time Transport Protocol) over UDP (User Datagram Protocol).

The client device receives the transmission packets, extracts data from the received packets to form the encoded stream and then decodes the stream to obtain decoded data, which can be either displayed or provided to a client application.

In case of transmission errors over the unreliable network 100, the client device applies error concealment to improve the quality of the decoded data. The embodiments of the invention as described below can be advantageously implemented by a client device 102 to enhance the quality of the decoded video data with reconstruction of missing parts.

FIG. 2 illustrates a block diagram of a device, in particular a client device 102, adapted to incorporate the invention.

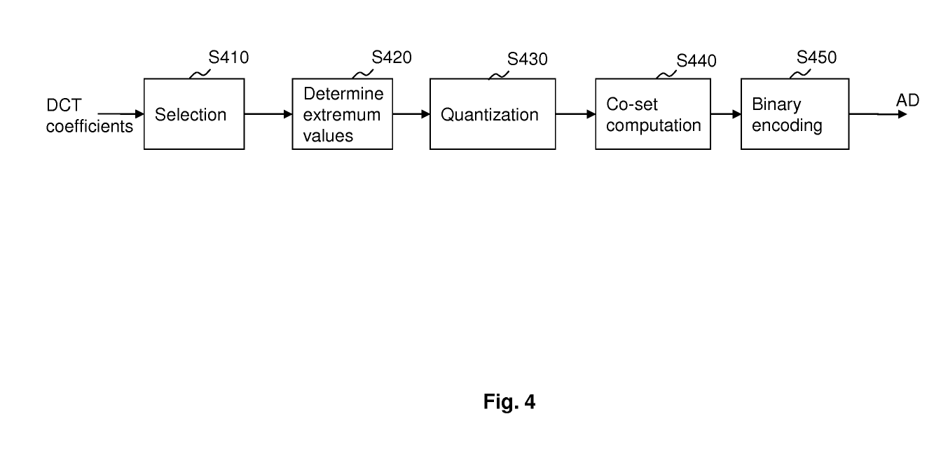

Preferably, the device 102 comprises a central processing unit (CPU) 201 capable of executing instructions from program ROM 203 on powering up, and instructions relating to a software application from main memory RAM 202 after the powering up. The main memory 202 is for example of Random Access Memory (RAM) type which functions as a working area of CPU 201, and the memory capacity thereof can be expanded by an optional RAM connected to an expansion port (not illustrated). Instructions relating to the software application may be loaded into the main memory 202 from a hard disk (HD) 206 or from the program ROM 203 for example. The software application or computer program, stored on non-transitory computer-readable carrier medium,_when executed by the CPU 201, causes the steps of the flowcharts shown in FIGS. 4, 7 and 9 to be performed on the client device 102.

A network interface 204 allows the connection of the device to the communication network. The software application when executed by the CPU 201 is adapted to receive data streams through the network interface from other devices.

A user interface 205 displays information to, and/or receives inputs from, a user.

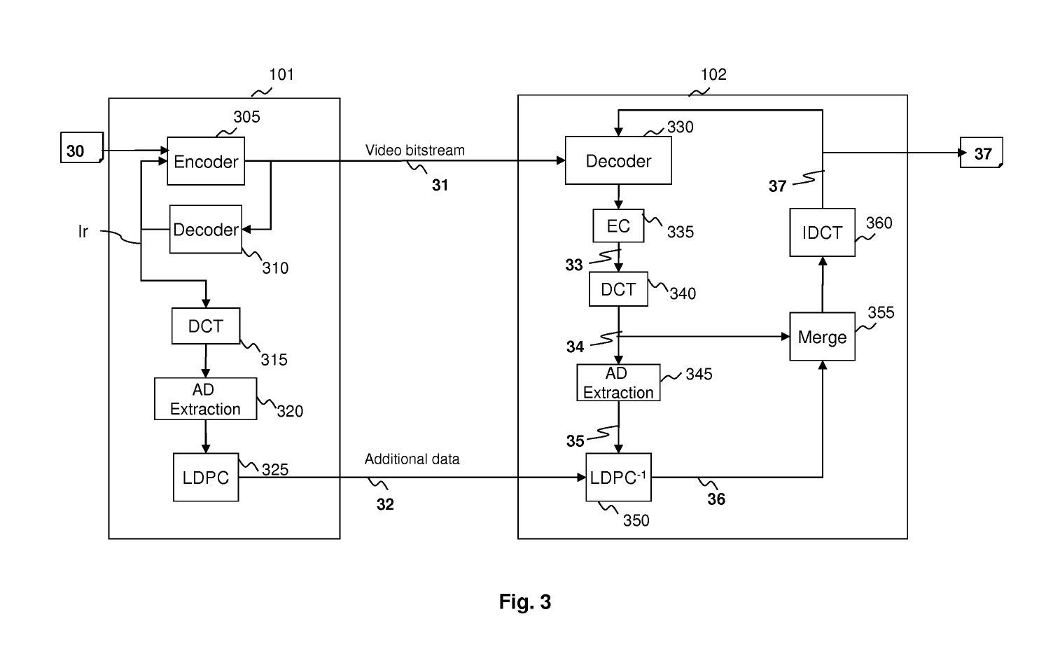

FIG. 3 illustrates a block diagram of a server and a client in a first embodiment of the invention. This embodiment applies to the improvement of the reconstruction of missing data due to transmission losses using error concealment. The processing is represented by connected modules, each module being adapted to implement, for example in the form of programming instructions, a corresponding step of a method implementing an embodiment of the invention.

The server device 101 receives from an external source, such as a camcorder for example, a sequence of digital images 30 to be encoded by an encoder 305. Alternatively, the sequence of digital images may have been stored in a memory of the server device 101 before processing.

The encoder 305 applies predictive compression using motion compensation according to one of the formats MPEG2, MPEG4 part 2 or H264 and outputs a video bitstream 31. The video bitstream 31 is composed of units that can be decoded independently, called NALU (for Network Abstract Layer Units) in H264 or slices in MPEG4 part 2. In the subsequent description, the units that are encoded and decoded independently are referred to as slices.

The video bitstream 31 is transmitted to a client device 102 via the communication network 100. In this example, the video bitstream is encapsulated into RTP (“Real-time protocol”) transmission packets which are sent via UDP.

The encoder 305 applies predictive type compression. Classically, in video compression standards (MPEG2, MPEG4 part 2, H264) the images of a video sequence can be compressed according to one of the following modes: Intra mode (I), inter prediction mode (P) and bi-directional prediction mode (B).

We note that in the subsequent description, a digital image is represented by a set of samples, each sample having an associated value. The samples representative of the image may either be the pixels forming an image in the spatial domain, or the set of transform coefficients forming an image in the transform domain.

In the Intra mode, an image is divided into blocks of samples (typically, blocks of 8×8 pixels). A transform is applied on each block, for example a Discrete Cosine Transform (DCT). Next, quantization (Q) is applied. The quantization is a lossy transformation, since the values obtained after de-quantization (or inverse quantization) may be different from the values before quantization. After quantization, a lossless coding such as entropy coding is applied to obtain a bistream corresponding to an Intra image.

In a prediction mode, an image is also divided into blocks of samples, but each block is encoded with respect to a reference block of a reference image, which has been encoded previously. In the Inter prediction mode (P), only one reference block from one reference image is used. In bi-directional prediction mode (B), a block is encoded with respect to two reference blocks, belonging respectively to two reference images.

The reference blocks are extracted from encoded/decoded reference images Ir, so as to have the same reference blocks at the encoder and at the decoder in case of lossless transmission.

For this reason, the server device 101 further comprises a decoder module 310 which carries out decoding of the video bitstream 31 encoded by the encoder module 305 generating such an encoded/decoded reference image Ir.

In the inter prediction mode (P), the reference image can be the previous image or another image of the video sequence which has already been coded. The reference block is subtracted from the block to code, and then the difference signal (also known as residual) is transformed using for example a DCT, then quantized. Finally, an entropy coding is applied to the quantized transformed residuals of a group of predicted blocks which are encoded as a slice.

Further, the motion vector corresponding to each predicted block is also encoded in the video bitstream. For example, information identifying the reference image Ir (e.g. its temporal index) and the coordinates of the motion vector are encoded. The coordinates of the motion vector may be non integer (½ or ¼ of pixel).

Both for Intra and Inter modes, if an error occurs during the transmission of a slice, the whole slice is rendered impossible to decode. The number of slices in a video is not imposed by the standards. A low number of slices gives a better compression but a lower error resilience. For example ten slices could be created in a HD (High Definition) image.

The server 101 also generates additional data 32, which is derived from auxiliary data representative of some of the digital images of the sequence of images to be encoded, according to a Wyner-Ziv type encoding scheme. Auxiliary data is generated from an encoded/decoded image by modules 315 and 320, and then the additional data 32 to be transmitted to the client device is calculated from the auxiliary data.

Firstly, module 315 applies a transform (such as a DCT transform, similarly to the encoder 305) after a division into blocks of encoded/decoded image to obtain blocks of transform coefficients. For example, for a block of 8×8 pixels, a set of 64 transform coefficients is obtained.

Next, a module 320 is dedicated to the extraction of auxiliary data from the blocks of transform coefficients.

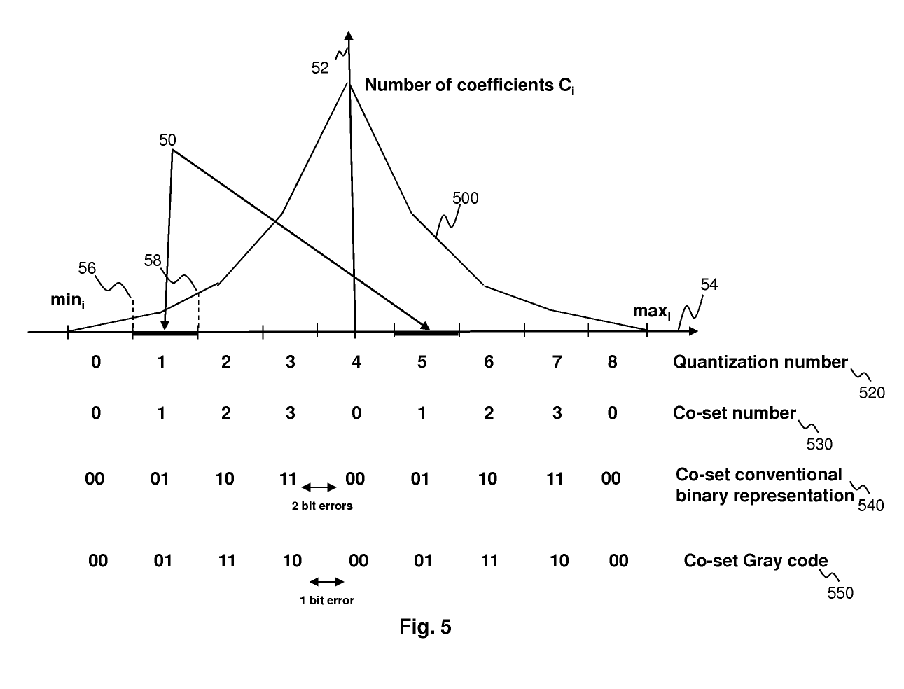

The auxiliary data extraction will be described in detail with respect to FIGS. 4 and 5. The result of the auxiliary data extraction module 320 is a set of symbols (equal to the number of blocks obtained for the image to be processed) represented with a predetermined number of bits per block.

Next, an error correction code of the symbols representing each block is computed by module 325. In the preferred embodiment, the Low Density Parity Check (LDPC) code is used.

In alternative embodiments, other error correction codes known in the art, such as turbo codes, can be applied.

An LDPC code is a linear block code. An error correction code can be characterized by the values (n,k), where n is the number of symbols of a code word and k is the number of symbols of the information word. Knowing n and k, it is possible to compute the number of parity symbols m=n−k and the code rate R=k/n. Typically in an LDPC code, the sizes k and m are very large.

In this embodiment, the LDPC code is applied on a subset of transformed and quantized coefficients of the image. For example, if the video is in HD format (High Definition), an image is represented by 1080×1920 pixels. An image is divided into blocks of 8×8 pixels on which a DCT is applied, resulting in 32400 blocks. In this case, k=32400 and using a code rate R of 0.91, we obtain m=3240 parity symbols. The advantage of using a very large size LDPC code adapted to the size of the image (typically, adapted to the number of blocks of the image) is that the spatial locations of the blocks are taken into account. For example, each block of quantized coefficients has an associated code symbol. Typically, the errors are spatially localized since they correspond to slices containing lost image data. A large size LDPC code makes it possible to correct badly concealed areas using the correctly received and decoded image data, for example corresponding to slices correctly received surrounding a lost or corrupted slice.

In this embodiment of a Wyner-Ziv type encoder, only the parity symbols (also known as check symbols) are transmitted as additional data 32 to the client device 102. In an embodiment, the additional data 32 is transmitted in a separate RTP stream, different from the RTP stream transporting the video bitstream 31. In an alternative embodiment, it is possible to integrate the additional data 32 within the video bitstream 31, for example using a SEI extension in format H264 (standing for Supplemental Enhancement Information, which is additional non standard metadata defined in H264 format for carrying enhancement information that can be used by a compliant decoder). In this alternative embodiment, a single data stream is transmitted from the server 101 to the client 102, containing both the video bistream 31 and the Wyner-Ziv additional data 32.

The client device 102 receives the video bitstream 31 and the additional data 32. In practice, the data is received in the form of transmission packets through a network interface 204 (shown in FIG. 2), and a de-packetizer module (not shown in FIG. 3) extracts the data corresponding to the video packets from the transmission packets and the video packets containing the slice data are concatenated. The video bitstream is then decoded by the decoder module 330.

Slices received without error are processed by the decoder module 330 based upon the format of the bitstream.

For the slices containing at least one error, which are also referred to as corrupted slices, error concealment is applied.

Module 335 of the client device 102 implements as a first decoding method an error concealment method EC.

An error concealment EC is a reconstruction method which conceals the losses by replacing the lost blocks of pixels (corresponding to the corrupted slice or slices) by blocks of pixels obtained from received data. Any suitable error concealment method may be implemented by module 335.

In a preferred embodiment, the error concealment method applied is motion extrapolation, which generally gives good results for sequences of images encoded according to a predictive format, in particular in the case of continuous motion with no acceleration. In motion extrapolation, the motion vectors between the two previous images (Iₜ₋₁,Iₜ₋₂) of the video sequence are inverted to project the previous image (Iₜ₋₁) on the missing or corrupted parts of the current image (Iₜ).

Alternatively, another possible error concealment method is motion interpolation, which is efficient in presence of acceleration or change of motion in the image sequence. In motion interpolation, the motion vectors of the blocks belonging to the missing or corrupted area are calculated from the motion vectors of the surrounding blocks of the current image which have been received without errors.

After applying the error concealment method, a first decoded image 33, which comprises a concealed part, is obtained.

However, even with a good error concealment method, the first decoded image 33 is different from the corresponding original image at the encoder. In a classical system, the first decoded and concealed image 33 may create a bad visual effect when displayed, and because of the prediction encoding, the low visual quality may be propagated to the following images.

The additional data received can be used in a second decoding step, to correct some parts of the decoded and concealed image and consequently to enhance the visual quality of the reconstructed image and to avoid error propagation to the following images of the sequence of digital images.

The decoded and concealed image 33 is then processed to extract auxiliary data, similarly to the processing applied at the encoder.

First, module 340 applies a block based DCT transform to obtain blocks of transform coefficients (34), similarly to module 315 of the encoder.

Subsequently, module 345 extracts concealment auxiliary data 35 from the transform coefficients obtained previously, similarly to module 320 of the encoder.

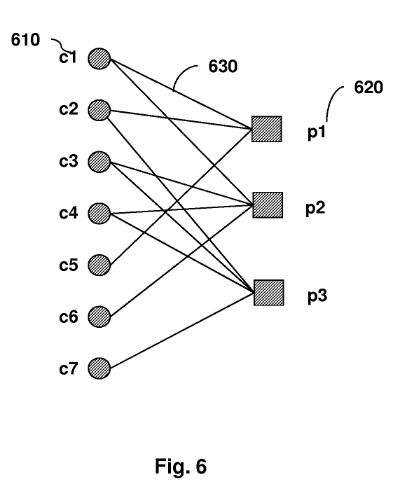

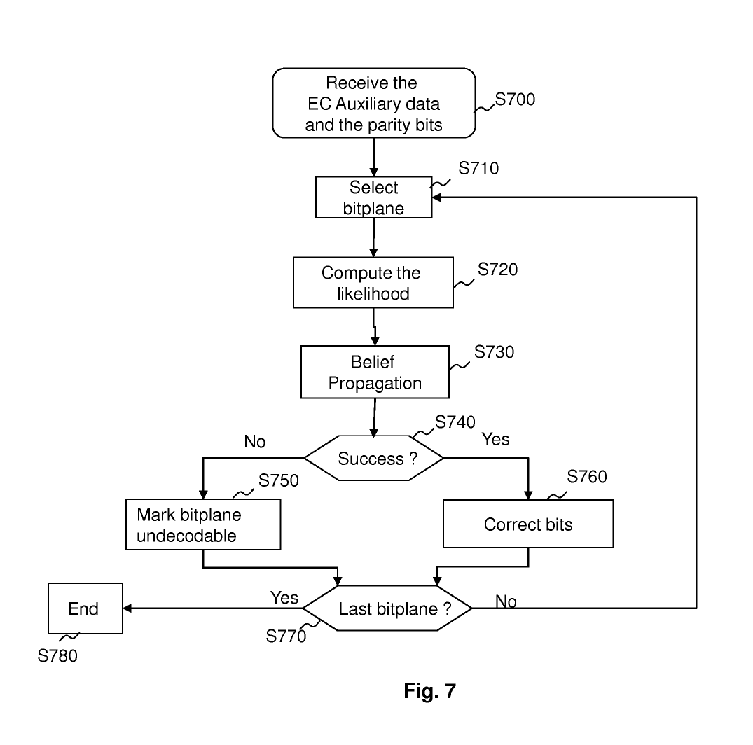

The received additional data 32 is then used to correct the extracted auxiliary data 35 by module 350 which applies error correction decoding, as described in more detail hereafter with respect to FIGS. 6 and 7. In the preferred embodiment the additional data contains parity symbols of an error correction code of the auxiliary data. The error correction decoding module 350 provides corrected or partially corrected auxiliary data 36.

Depending on the amount of errors, due for example to transmission losses, the auxiliary data may be only partially corrected, as explained in more detail with respect to FIG. 7.

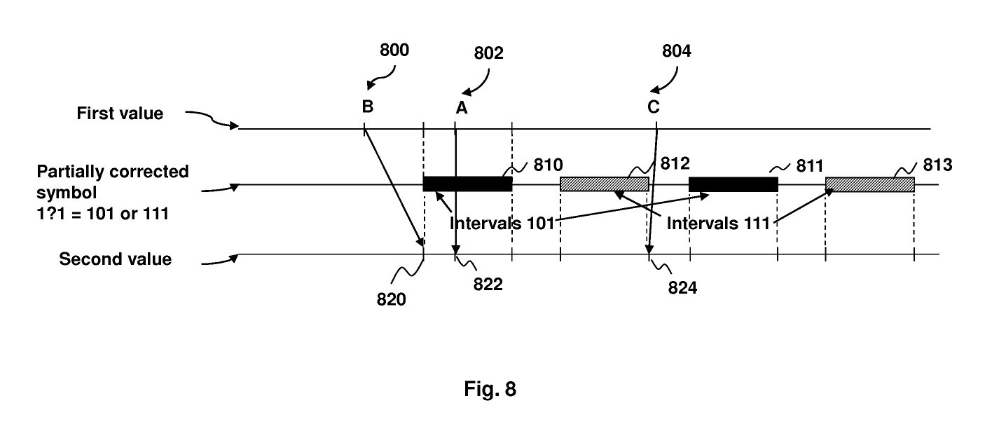

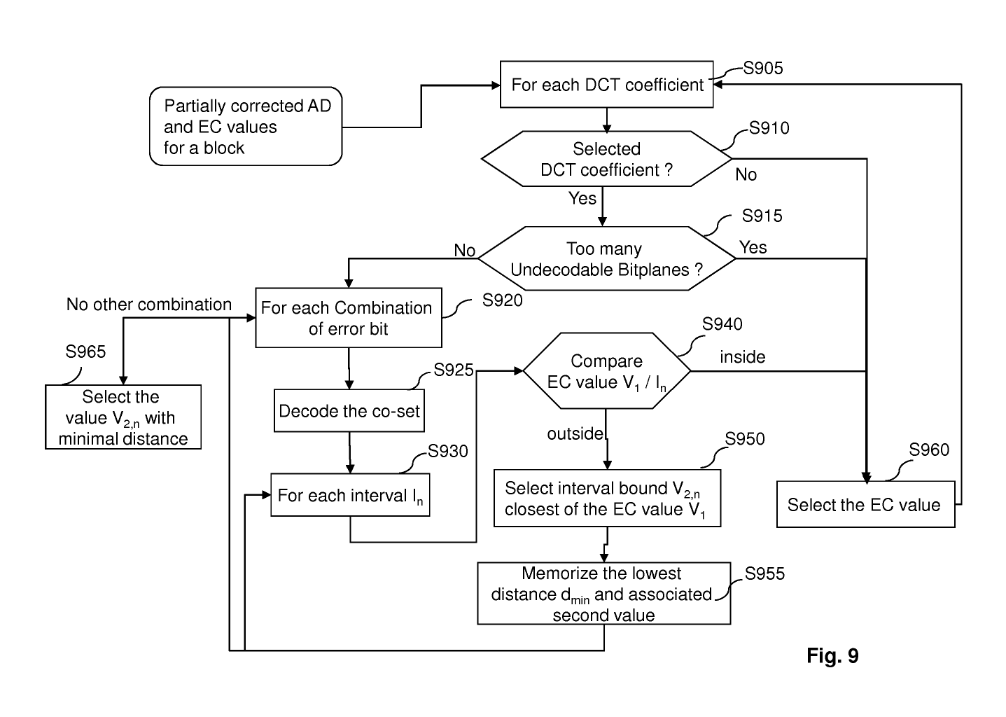

However, advantageously, the corrected and the partially corrected auxiliary data, as well as the DCT values 34 are used by the merge module 355, which outputs final corrected transform coefficients. An embodiment of the improvement of the DCT values is explained hereafter with respect to FIGS. 8 and 9.

Once the final corrected transform coefficients have been obtained for each block, the inverse transform module 360, which applies an inverse block DCT in this embodiment, outputs the final decoded and corrected current image 37.

The resulting corrected image 37 may be output to an application (for example displayed), and also stored to be subsequently used as a reference image by the decoder module 330.

FIG. 4 illustrates an embodiment of the auxiliary data extraction and generation applied by modules 320 at the encoder and 345 at the decoder.

The transform coefficients of the blocks of the current image are provided as an input.

At step S410, a subset of transform coefficients are selected for each block. For example, only a given number of coefficients corresponding to the low frequencies are selected. Classically, the transform coefficients can be ordered as a one-dimensional list of coefficients according to a so-called zig-zag scan, ordering the coefficients in the order of increasing frequencies and associating an index or number to each coefficient. The first N coefficients of the list are selected at step S410. In a preferred embodiment, N=3, so that coefficients of index i {0≦i<3} are selected.

It is advantageous to select a given number of coefficients, in particular the first coefficients corresponding to the lower frequencies, since the visual impact of low frequencies is more important than the visual impact of high frequencies. Auxiliary data selected in this way is therefore more efficient for correcting the error concealment results at the decoder. Moreover, error concealment generally better predicts the low frequencies than the high frequencies. Thus the auxiliary data selected in this way is better suited within the Wyner-Ziv scheme. In other words, for the same correction quality, the auxiliary data can be better compressed.

Next, at step S420, the minimum and maximum values for each selected coefficient are determined. For each coefficient of a given index i, 0≦i<3, the minimum (minᵢ) and maximum (maxᵢ) values are computed considering all blocks of the image, and then a uniform quantization is applied between those minimum and maximum values at step S430. The number of quantization intervals is determined depending on the number M of bits chosen for representing each coefficient.

In the simplest implementation, an integer value representing an index of the quantization interval, also called quantization number (referral number 520 in FIG. 5), is directly encoded to represent the quantized value. In this case, in order to obtain a representation on M bits, the range between the minimum and maximum values is divided into 2^{M} quantization intervals.

However, in the preferred embodiment, the quantization number is encoded using co-set representation computed at step S440, and illustrated in FIG. 5. In this embodiment, in order to obtain a representation on M bits, 2^{M+1}+1 quantization intervals are created between the minimum value minᵢ and the maximum value maxᵢ for each coefficient. In the example of FIG. 5, M=2 and there are 9 quantization intervals with 4 different co-set numbers 0 to 3.

Note that at the decoder side, the minimum and maximum values per coefficient are not computed, but retrieved from the additional data 32 received, so as to ensure that the same quantization is applied at the encoder and at the decoder side. Alternatively, another parameter representative of the quantization interval for each coefficient, such as the quantization step, is transmitted to the client device along with the additional data 32. Similarly, the number of quantization intervals or alternatively the number M of bits per coefficient is known at the decoder side, being either transmitted or pre-determined.

FIG. 5 illustrates a typical distribution of the values of a given DCT coefficient Cᵢ in a current image. The horizontal axis 54 represents the values of the given coefficient Cᵢ, which in practice vary between minᵢ and maxᵢ. The vertical axis 52 represents the number of coefficients of index i, Ci, among the blocks of the current image, taking a value given by the horizontal axis. As shown in FIG. 5, a typical distribution 500 of an AC coefficient (coefficients of index i>0), for example the first frequency coefficient C₁, is centered around the value zero, i.e. in most blocks of an image, the value of C₁ is close to 0.

An uniform quantization is illustrated in FIG. 5: the range between min, and max, is divided into nine equal ranges or quantization intervals, each of which is attributed a different quantization number 520 from 0 to 8. Each quantization interval is defined by its bounds, for example the lower bound 56 and the upper bound 58 of the quantization interval having quantization number one in FIG. 5.

The quantization intervals can be grouped into co-sets 50, which are attributed a co-set number 530 varying between 0 and 3. The same co-set number is given to two or more quantization intervals, which advantageously achieves a more compact representation of the additional data derived from the auxiliary data. Therefore, an equal improvement can be obtained at the decoder with more compact additional data.

The number of quantization intervals of each co-set may be different. In the preferred embodiment, as illustrated in FIG. 5, the same co-set number 0 is associated to the middle quantization interval (containing the coefficient value 0) and to the two extreme quantization intervals. The remaining quantization intervals are grouped by two, so that co-set numbers 1, 2, 3 each have two associated quantization intervals.

As shown in the example, quantization sub-sets 1 and 5 are assigned the same co-set number 1. This has the advantage of reducing the number of bits for coding a value of a transform coefficient. However, the information cannot be decoded as such, as at the decoder there would be an ambiguity as on how to decode a received co-set number. Supplementary information is necessary at the decoding.

In the Wyner-Ziv type encoding/decoding scheme represented in FIG. 3, such supplementary information is provided by the transform coefficients obtained by decoding and error concealment. Therefore, the co-set representation of the quantization intervals is well adapted in a Wyner-Ziv type encoding scheme for the representation of the auxiliary data. Advantageously, co-set representation of the quantization intervals allows compaction of the representation of the auxiliary data.

As further shown in FIG. 5, the co-set numbers can be simply encoded using the conventional binary representation 540. However, as shown in the figure, two consecutive values of the conventional binary representation may differ by more than one bit. However, when error concealment is applied, often the predicted coefficient values are close to the original coefficient values, so generally, the quantized values are likely to be also close. Therefore, it is more advantageous to represent the quantized values with a code which has a Hamming distance of 1, meaning that two consecutive values differ only by one bit. Such a binary representation is illustrated in FIG. 5 by the co-set Gray code 550.

Back to FIG. 4, the quantized values obtained at step S430 are represented with co-sets, computed as explained above with respect to FIG. 5. In step S440, each co-set is assigned a co-set number 530. Next, at step S450, a binary encoding is applied on the co-set numbers obtained at step S440. In the preferred embodiment, a Gray code representation 550 is advantageously chosen.

Alternatively, a different type of quantization could be applied at step S430, for example a quantization with a dead zone around zero using 2^{M} quantization intervals.

Further, in an alternative embodiment, steps S440 and S450 could be replaced by a single step of binary encoding of the unique quantization numbers 520 associated with each quantization interval.

In another embodiment the step 450 could consist in shuffling the bits of the value obtained for each coefficient. A different shuffle order is applied in each block. However the order is selected deterministically so the decoder can unshuffle the bits of each coefficient. This embodiment as the advantage to give the same error probability for each bitplane and thus it can give a higher probability of decoding all the bitplanes. A bitplane is composed of all bits of same rank taken from each symbol, therefore each bitplane contains a bit per block.

An example of the error correcting coding module 325 and of the error correcting decoding modules 350 will now be given with respect to FIGS. 6 and 7.

As already explained above, in the preferred embodiment, the LDPC (Low Density Parity Check) code is used by the error correction module 325 at the encoder to output the parity symbols which can serve for the correction of errors in auxiliary data.

Alternatively, other error correction codes such as turbo codes could be used.

An LDPC code is a linear code, defined by a sparse Boolean matrix H, also called the parity matrix.

FIG. 6 represents graphically a parity matrix H, also known as LDPC matrix, of a very simple linear code of size (7,4), illustrated for the ease of explanation.

For example the matrix equivalent to FIG. 6 is

$$H = [ \begin{matrix}1 & 1 & 0 & 0 & 1 & 0 & 0 \\ 1 & 0 & 1 & 1 & 0 & 1 & 0 \\ 0 & 1 & 1 & 1 & 0 & 0 & 1\end{matrix} ] ,$$

which is a Boolean matrix.

Given a word c=[c₁,c₂,c₃,c₄,c₅,c₆,c₇] composed of 7 symbols, it can be checked that the word is a code word by verifying that:

$$H {\underline{c}}^{T} = [ \begin{matrix}0 \\ 0 \\ 0\end{matrix} ] \qquad ( 2 )$$

where c^{T} is transposed from vector c.

It should be noted that the arithmetical operations are carried out as follows. The addition is the binary XOR operation and the multiplication is the binary AND operation. Note that addition and subtraction are the same operation and the inverse of a symbol is the symbol itself.

The parity matrix H is equivalent to the graph represented FIG. 6: the symbols of word c 610 are at the left of the graph and the check nodes p 620 which must be null are at the right. The symbols checked by each check node are linked to the check node. The links 630 between the symbols cᵢ and the nodes pᵢ of FIG. 6 represent the lines of parity matrix H.

For example, when applying the parity check (2) with the first line of matrix H, the following relationship is obtained:

p₁=c₁+c₂+c₅=0

When H has the form [−R^{T}|Iₙ₋ₖ], i.e. the last n−k columns of H are equal to the identity matrix of size n−k, Iₙ₋ₖ, it is easy to compute the generating matrix G=└Iₖ|R┘, where G is composed of the identity matrix of size k, Iₖ, and the transpose of the inverse of the first part of H, denoted R, of k lines and n−k columns. Given an information word u=[u₁,u₂,u₃, u₄], then u·G=c.

The code is systematic: the first k values of the code word c (c₁, c₂, c₃, c₄ in this example) are equal to the information word u composed of k information symbols. The last (n−k) values of c (c₅, c₆, c₇ in this example) are the parity symbols which are transmitted as additional data 32.

In a regular LDPC code, the sparse matrix R is selected with the constraints that on each column the number of bits equal to 1 is fixed to a small value, for example equal to 3, so that each symbol is used for 3 checks.

In an alternative embodiment, an irregular LDPC matrix such as a Tornado code can be used, as described in Michael G. Luby, Michael Mitzenmacher, M. Amin Shokrollahi, Daniel A. Spielman, Volker Stemann, “Practical loss-resilient codes”, Proceedings of the twenty-ninth annual ACM symposium on Theory of computing, p. 150-159, May 4-06, 1997, El Paso, Tex., United States.

In the current embodiment, the matrix R is created and made available to the modules 325 and 350 before the video transmission. The matrix R depends on the number of blocks per image since in this embodiment, an information symbol is obtained from the quantized coefficients selected for a block.

In an alternative embodiment, it is possible to transmit from the server 101 to the client 102, along with the parity symbols data, either the matrix R or some parameters allowing the error correction decoding module 350 to generate exactly the same matrix R as used by module 325.

The encoding module 325 thus applies a multiplication by R to the binary encoded quantized data provided by module 320. In this operation, since an information symbol is formed by the selected quantized coefficients of a DCT block, all operations (XOR and AND) are thus applied per block and consequently, the encoding is very fast.

FIG. 7 is a flowchart of an embodiment of an error correction decoding method implemented by the error correction decoding module 350. All the steps of the algorithm represented in FIG. 7 can be implemented in software and executed by the central processing unit 201 of the device 102.

The error correction decoding module 350 implements an error correction decoding based on the probabilities of error per bit. In an embodiment, the algorithm applied is the algorithm called ‘belief propagation’, described in the article “Good error-correcting codes based on very sparse matrices”, by D. J. C. MacKay, published in IEEE Transactions on Information Theory 1999, vol. 45, pp. 399-431.

The algorithm of FIG. 7 receives as an input (step S700) the concealment auxiliary data, (35 in the example of embodiment of FIG. 3), as well as the additional data received 32, which contains the parity symbols computed at the error correction encoding 325.

Next, at step S710, a bitplane to be processed is selected. Each symbol is encoded on a given number of bits, each bit having an associated rank from the most significant bit (MSB) to the least significant bit (LBS). For example, a symbol S encoded on 4 bits can be written as S=b₃2³+b₂2²+b₁2¹+b₀2⁰=Σbᵢ2ⁱ, b₃ being the most significant bit of S and b₀ being the least significant bit of S.

A bitplane is composed of all bits of same rank taken from each symbol, therefore each bitplane contains a bit per block. In this embodiment, each symbol is composed of the binary representations of several quantized DCT coefficients. For example, if a symbol S encoded on 4 bits comprises two DCT coefficients C₁ and C₂, then the first two bits (b₃,b₂) correspond to C₁ and the next two bits (b₁, b₀) correspond to C₂.

If a Gray code was used as a binary representation of the quantized transform coefficients or if the bits of each coefficient have been shuffled, then all the bitplanes are independent. In that case, the bitplanes can be decoded in any order, so any bitplane that has not yet been decoded can be selected at step S710. If a conventional binary encoding was used for representing the quantization numbers, then the order of the bitplanes has an importance, and if the most significant bit planes contain errors, the corresponding quantization number cannot be decoded. Therefore, in case a conventional binary encoding is used in step S450, the bitplanes must be selected at step S710 starting from the most significant bitplane to the least significant bitplane.

After the selection of a bitplane to be processed has been achieved at step S710, then at step S720 the probabilities per bit are computed for each bit of the selected bitplane, expressed as a probability ratio which is called the likelihood: for each bit, the probability of its value being 1 divided by the probability of its value being 0. As the algorithm progresses, these probability ratios will be modified taking into account information obtained from other bits, in conjunction with the requirement that the parity checks be satisfied.

Let p be the probability of a bit b to be incorrect.

The likelihood (or probability ratio) associated with the bit b is the following:

$$if b = 1 , likelihood ( b ) = \frac{( 1 - p )}{p}$$

$$if b = 0 , likelihood ( b ) = \frac{p}{( 1 - p )}$$

In the corrupted area of the signal, typically a slice that cannot be decoded and on which an error concealment is applied, the value of p is set to a predetermined value, for example p=0.1. Typically, in a simple embodiment, the same value of p is associated to every bit of every symbol representing a transform coefficient of a block belonging to the corrupted image area.

In the image areas where no transmission error occurred and thus the decoded value is correct, p is set to a value very close to 0, typically p=0.0001, such that the likelihood for a value b=0 is 0 and the likelihood for a value b=1 is the maximum acceptable integer value for the CPU 201.

With a conventional binary encoding there is a dependency between the bit correctness from different bitplanes. Thus if the decoding of a bit is incorrect in step S760, the lower order bits of the same DCT coefficient will be set to a likelihood of 1 to indicate a high probability of error (typically, p=0.5).

The ‘belief propagation’ algorithm is applied at step S730.

For each parity check, the algorithm computes a probability ratio for every bit that participates in that parity check. These ratios give the probability of that parity check being satisfied if the bit in question is 1 divided by the probability of the check being satisfied if the bit is 0, taking account of the probabilities of each of the other bits participating in this check, as derived from the probability ratios for these bits with respect to this check.

For every bit, the algorithm computes a probability ratio for each parity check in which said bit symbol is involved, giving the probability for that bit to be 1 versus 0 based only on information derived from other parity checks, along with the data received for the bit.

The algorithm alternates between recalculating the probability ratios for each check and recalculating the probability ratios for each bit.

At the end of each iteration, an evaluated value for each bit is computed from the likelihood.

A first simple embodiment consists to compare the likelihood to 1. If the likelihood is lower than 1 the bit value is estimated to be 0 otherwise, the bit value is estimated to be 1.

A better solution will be to test if the likelihood is greater than a threshold, for example T1=1.5, then the evaluated bit value is 1; otherwise, if the likelihood is lower than a second threshold (for example T2=0.66), then the evaluated bit value is 0. If the likelihood is between T1 and T2, then the bit value cannot be evaluated.

If the value of each bit of the selected bitplane can be evaluated, then the check values 620 are computed from the evaluated bit values using the classical LDPC decoding.

The algorithm stops (test S740) if all checks are verified (Hc^{t}=0), in which case the correction has succeeded and the bitplane is fully corrected, or after a predefined number of iterations, in which case the correction has failed. Typically, if the number of bit errors in the selected bitplane is sufficiently low, the ‘belief propagation’ decoding algorithm corrects all bits and stops rapidly. On the contrary, if the number of bit errors is too high, the ‘belief propagation’ decoding algorithm does not converge. The experiments have shown that for example a number of 20 iterations is sufficient.

If the algorithm has failed (answer ‘no’ to test S740), the selected bitplane is marked as undecodable at step S750. This means that the number of bit errors in the bitplane is high, and that the selected bitplane of the auxiliary data has not been completely corrected.

In a first embodiment, it may be considered that all bits in this bitplane may be incorrect and therefore have an unknown value.

An alternative embodiment could also take into account the likelihood of the bits that has been reached after the maximum number of iterations in order to better evaluate which bits are incorrect. For example only the blocks where the likelihood of the bit is between the thresholds T1 and T2, will be considered as not corrected and therefore having an unknown value.

If the algorithm has succeeded (answer ‘yes’ to test S740), then the selected bitplane has been completely corrected. It is thus possible to find out exactly which bits of the selected bitplane of the auxiliary data provided as an input are incorrect and inverse their value in the auxiliary data.

In the case where the conventional binary representation is used, if a bit belonging to a given DCT coefficient is incorrect and has been corrected, the lower order bits of the same DCT coefficient have a high probability to be also incorrect. This information can be used to compute the likelihood for the corresponding bits at step S720.

Both steps S750 and S760 are followed by step S770, at which it is checked whether the currently selected bitplane is the last bitplane of the symbols of the auxiliary data.

If it is not the last bitplane, then the next remaining bit plane is selected and the steps S720 to S770 are repeated.

We note that if the conventional binary representation is used, and the processed bitplane has been marked as undecodable, then it is useless to process the following bitplanes of the same DCT coefficient containing the selected bitplane. In this case and if this was the last DCT coefficient or if the currently selected bitplane is indeed the last bitplane of the auxiliary data, the error correction decoding stops (step S780).

FIG. 8 illustrates examples of first and second values according to an embodiment. On the top line, several possible first values 800, 802, 804, which are approximate values of a DCT coefficient obtained for example by error concealment are represented. In the example of FIG. 8, a symbol representative of a quantization interval is represented on 3 bits. The middle line represents several possible quantization intervals corresponding to a partially corrected symbol representative of a quantization interval. In this example, the middle bit of the three bits representing a quantization symbol has not been corrected by the error correction decoding, and therefore its value is unknown. The partially corrected symbol in the example is 1?1, having two possible values, respectively 101 or value 111.

In this example, the symbol is representative of a co-set number, and each possible value of a co-set number designates two quantization intervals. In the figure, co-set value 101 corresponds to quantization intervals 810 and 811, and co-set value 111 corresponds to intervals 812 and 813.

When the approximate DCT value is comprised within one of the possible quantization intervals, such as value A 802 of FIG. 8 which belongs to interval 810, the approximate first value is not modified. The corresponding second value 822 or corrected value obtained is therefore identical.

When the approximate DCT is not included in any of the possible intervals, the corresponding corrected value (second value) is selected as the closest bound of one of the possible intervals. For example, value B 800 is replaced by value 820 which is the lower bound of interval 810 and value C 804 is replaced by value 824 which is the upper bound of interval 812.

This example explains an embodiment of improving some approximate values obtained by a first reconstruction of a missing area by one of a plurality of possible values indicated by an error correction decoding.

The example of FIG. 8 illustrates the choice of improved values which correspond to lower or upper bounds of possible quantization intervals, but alternatively, other suitable values belonging to the possible quantization intervals may be chosen. This selection is very easy to compute and improvement of the quality of reconstruction has been construed by experiments. Therefore, this embodiment provides a very good compromise in terms of computation load vs the quality of reconstruction.

FIG. 9 is a flowchart illustrating an embodiment of the improving of transform coefficients corresponding to missing samples representative of a missing area, as implemented by the merge module 355 of FIG. 3. All the steps of the algorithm represented in FIG. 9 can be implemented in software and executed by the central processing unit 201 of the device 102.

For a given block of coefficients to be processed belonging to a missing part of the image, the input of the algorithm of FIG. 9 is the partially corrected auxiliary data 36 corresponding to the block and the first coefficient values 34, representative of the missing samples, obtained by applying a transform (e.g. a DCT transform) after error concealment in the embodiment of FIG. 3.

The merge module 355 processes each DCT coefficient of the block (S905).

Firstly, it is checked in step S910 whether the DCT coefficient to be processed is one of the DCT coefficients selected for the auxiliary data, as explained with respect to step S410.

In case of negative answer to test S910, no correction is possible, and thus the first DCT value is not modified (step S960). The following DCT coefficient is then processed if there are any remaining DCT coefficients to process in the block, so the algorithm return to step S905.

In case of positive answer, step S910 is followed by step S915 to determine whether the number of undecodable bitplanes of the current DCT coefficient is compatible with a further correction. The number of undecodable bitplanes has been recorded previously, during error correction decoding, as explained above with respect to step S750 of FIG. 7. This number is therefore retrieved and compared to a threshold, for example equal to 4.

If the number of undecodable bitplanes for the current DCT coefficient is higher than the predetermined threshold, no further improvement is applied and step S915 is followed by step S960. The first value of the coefficient is kept unchanged and the processing continues with the next DCT coefficient.

If the number of undecodable bitplanes for the current coefficient is lower than the predetermined threshold, step S915 is followed by step S920. All the possible values of the partially corrected symbol obtained from the partially corrected auxiliary data 36 are computed. For example, as shown in FIG. 8, if the symbol retrieved has one unknown bit, e.g. 1?1, there are two possible values, e.g. 101 and 111. If there are two unknown bits, e.g. 1??1, there are four corresponding possible values, e.g. 1001, 1011, 1101, 1111. The number of possible combinations increases exponentially in the number of unknown bits.

In this example of embodiment, each possible value is representative of a quantization interval via a co-set number. For each possible value, the corresponding co-set number is retrieved at step S925, and then the corresponding quantization intervals are identified. For example, as explained above with respect to FIG. 5, co-set number 1 corresponds to the quantization intervals 1 and 5.

This step is slightly more complex in the case of a Gray code encoding rather than a conventional binary encoding, but it can be efficiently implemented by using a decoding table giving the number associated to each Gray code value.

For each possible quantization interval Iₙ (S930), a test is applied at step S940 to determine whether the first value of the current coefficient (V₁), obtained from the error concealment belongs to the quantization interval Iₙ. If the first value is inside the quantization interval Iₙ, it is kept without modification, so step S940 is followed by step S960 already described. If the first value is outside the quantization interval Iₙ, then the bound V_{2,n} of the quantization interval Iₙ which is closest to the first value is selected (S950), and the distance dₙ between this selected value and the first value is computed, such as the absolute value of the difference (V₁−V_{2,n}).

Then, at step S955, the distance dₙ is compared to the lowest computed distance dₘᵢₙ for the current DCT coefficient. If the interval Iₙ is the first interval tested for the current DCT coefficient, then dₘᵢₙ is set to dₙ and the associated value V_{2,n} is memorized. If the current interval Iₙ is not the first interval tested for the current DCT coefficient, dₘᵢₙ is set to dₙ only if dₙ is lower than dₘᵢₙ, and the associated second value V_{2,n} is memorized.

The next possible quantization interval corresponding to the co-set number is then processed (S930). When all the quantization intervals have been tested, another possible co-set value is selected, so the algorithm returns to S920.

Finally, after all possible values obtained from the partially corrected auxiliary data have been tested, step S920 is followed by step S965 in which the final corrected second value is selected as the second value corresponding to the minimum distance dₘᵢₙ, as illustrated by the example of FIG. 8.

The second values obtained are improved with respect to the approximate first values obtained by error concealment, because they are more likely to be within the same quantization interval as the correct coefficient value, which would have been received if there was no missing data.

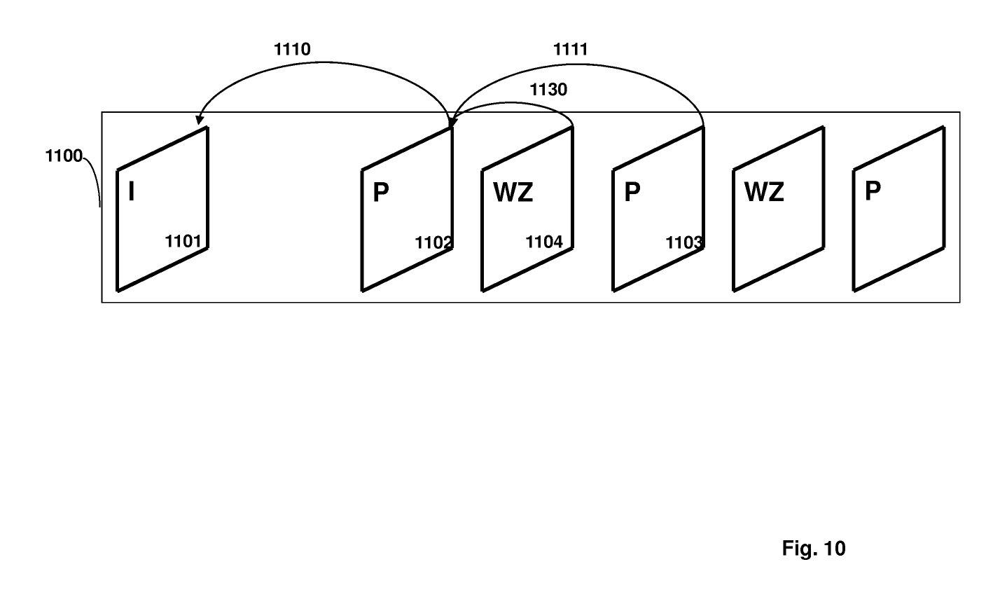

FIG. 10 describes a distributed video coding system to which a second embodiment of the invention can be applied. The objective of a distributed video coding method is to simplify the encoding by removing a part of the motion estimation. Indeed the motion estimation in the encoder uses a lot of computation.

In a standard video coding system, frames are encoded in Intra mode (I frames), or in predicted mode based on one reference frame (P frame) or two reference frames (B frame). In a distributed video encoder some frames may be encoded classically (frames 1101, 1102 and 1103) and some frames may be encoded in Wyner-Ziv mode (frame 1104).

In this example, frame 1104 is encoded as Wyner-Ziv additional data, which can be generated using a method similar to the method used in FIG. 3. The original image is transformed with a DCT transformation, then the auxiliary data is extracted and finally an LDPC is applied on all the quantized blocks. Only the Wyner-Ziv additional data is transmitted to the decoder.

With this method the encoder is simplified compared to a classical encoder because no motion vector needs to be computed for a Wyner-Ziv encoded frame (noted WZ frame on the figure). However some motion vectors are computed for the classical P frames (1102 and 1103).

At the decoder side, the classical I and P frames (1101, 1102, 1103) are decoded by a classical decoder.

The frames encoded with Wyner-Ziv or WZ frames can be considered as missing areas of the sequence of images. In this embodiment, the missing area is an entire frame.

For the WZ frame (1104) the decoder creates a first version of the frame using the received I and P frames, by applying a reconstruction method using available data, similarly to error concealment methods.

Many methods exist but we will describe two efficient methods based on predicted motion estimation.

The motion extrapolation (ME) method consists in using the motion vectors of the previous P image (1110) and then changing their orientation and scaling them to the distance between the WZ frame and the P frame. This new motion field (1130) is then used to predict the pixel values of the WZ image.

The motion interpolation (MI) method consists in using the previous and following frames (1102 and 1103). A motion field is computed between the two frames or the motion field 1111 determined by the encoder can also be used. Then the values of the pixels of the image 1104 are predicted by interpolation of the pixels of the two images using the computed motion.

These two reconstruction methods may give good results in some parts of the image and may fail in other parts of the image. Thus, it is possible to improve parts of the first version of the WZ frame using the method described with respect to FIGS. 8 and 9.

In this embodiment as well it is useful to avoid heavy computations at the encoder side to fit the amount of additional data to provide to the decoder in order to achieve successful correction of the reconstructed images at the decoder. Therefore, the method of improving the reconstruction of missing parts, even in the case where only partial correction is provided using the Wyner-Ziv additional data can be advantageously applied.

In the embodiments described above, the partially corrected data obtained is representative of quantization intervals corresponding to transform coefficients, such as DCT coefficients computed for a block of samples.

Other alternative embodiments may be envisaged, such as for example auxiliary data representative of pixels values or coefficient values. Similarly to the embodiments of FIGS. 8 and 9, several possible corrected values can be obtained for a given approximate first value of a sample, and then a choice of an improved value among the possible corrected values can be similarly applied to obtain and improved value.

More generally, any modification or improvement of the above-described embodiments, that a person skilled in the art may easily conceive should be considered as falling within the scope of the invention.

What we claim is:

1. Method for decoding a digital signal comprising at least one digital image encoded by an encoder, said digital image being represented by a plurality of samples,
the method comprising,
when a part of one said encoded digital image to be decoded is missing:
applying a first decoding to said encoded digital image having the missing part so as to obtain a first decoded image, the first decoding involving setting a missing sample, being one of said samples in said missing part, to a first value
applying a second decoding to said first decoded image using additional data, derived by the encoder from at least part of the encoded digital image and usable during decoding to correct the encoded digital image, to obtain a partially corrected symbol representative of said sample, said partially corrected symbol comprising at least one unknown bit, and
obtaining a second value for said missing sample based upon said first value and said partially corrected symbol.

2. A method according to claim 1, wherein said second value is used for reconstruction of said missing part.

3. A method according to claim 1, wherein the obtaining of said second value comprises:
obtaining at least two possible values for said missing sample from said partially corrected symbol, and
selecting as second value of said missing sample that one of said two possible values which is closest to said first value.

4. A method according to claim 1, wherein the obtaining of said second value comprises:
obtaining at least two ranges of values from said partially corrected symbol, and
obtaining a second value for said missing sample based upon said first value and said at least two ranges of values.

5. A method according to claim 4, wherein said second value is selected as the value belonging to one of said at least two ranges of values and which is closest to said first value.

6. A method according to claim 4, wherein said partially corrected symbol is representative of a quantized version of said missing sample and said ranges of values are quantization intervals.

7. A method according to claim 1, wherein said first decoding applies an error concealment reconstruction to reconstruct said missing part of said encoded digital image to be decoded.

8. A method according to claim 1, wherein said second decoding is an error correction decoding.

9. A method according to claim 8, wherein the additional data received for said encoded digital image comprises a set of parity symbols obtained at an encoder by applying an error correction encoding to auxiliary data extracted from a digital image corresponding to said encoded digital image to decode.

10. A method according to claim 9, wherein said second decoding comprises extracting such auxiliary data from said first decoded image.

11. A method according to claim 10, wherein the extracting of the auxiliary data comprises:
dividing said first decoded image into blocks of decoded pixels, and
applying a transform on each block of decoded pixels to obtain a block of transform coefficients.

12. A method according to claim 11, wherein the extracting of the auxiliary data from the first decoded image further comprises:
selecting a subset of transform coefficients of each block of transform coefficients, and
quantizing each selected transform coefficient using a predetermined number of bits, a quantization number being associated with each quantized coefficient.

13. A method according to claim 12, further comprising associating a co-set number to a plurality of said quantization numbers.

14. A method according to claim 12 or 13, wherein said extracted auxiliary data is binary encoded using a Gray code representation.

15. A method according to claim 7, wherein the error correction decoding is an LDPC error correction decoding.

16. Device for decoding a digital signal comprising at least one digital image encoded by an encoder, said digital image being represented by a plurality of samples,
the device comprising:
a first decoding unit which, when a part of one said encoded digital image to be decoded is missing, applies a first decoding to said encoded digital image having the missing part so as to obtain a first decoded image, the first decoding unit involving setting a missing sample, being one of said samples in said missing part, to a first value
a second decoding unit which applies a second decoding to said first decoded image using additional data, derived by the encoder from at least part of the encoded digital image and usable during decoding to correct the encoded digital image, to obtain a partially corrected symbol representative of said sample, said partially corrected symbol comprising at least one unknown bit, and
an obtaining unit which obtains a second value for said missing sample based upon said first value and said partially corrected symbol.

17. A non-transitory computer-readable carrier medium storing a program which, when executed by a computer or a processor in a device for decoding a digital signal, causes the device to carry out a method for decoding a digital signal comprising at least one digital image encoded by an encoder, said digital image being represented by a plurality of samples, said method comprising,
when a part of one said encoded digital image to be decoded is missing:
applying a first decoding to said encoded digital image having the missing part so as to obtain a first decoded image, the first decoding involving setting a missing sample, being one of said samples in said missing part, to a first value
applying a second decoding to said first decoded image using additional data, derived by the encoder from at least part of the encoded digital image and usable during decoding to correct the encoded digital image, to obtain a partially corrected symbol representative of said sample, said partially corrected symbol comprising at least one unknown bit, and
obtaining a second value for said missing sample based upon said first value and said partially corrected symbol.
